(19) United States
(12) Patent Application Publication
(10) Pub. No.: US 2023/0202558 A1
(43) Pub. Date: Jun. 29, 2023

(54) AUTOMATIC STEERING CONTROL DEVICE AND AUTOMATIC STEERING CONTROL SYSTEM FOR VEHICLE

(71) Applicant: Mitsubishi Electric Corporation, Tokyo (JP)

(72) Inventors: Michihiro OGATA, Tokyo (JP); Kenta TOMINAGA, Tokyo (JP); Masaya ENDO, Tokyo (JP); Hiroyuki KOBAYASHI, Tokyo (JP)

(73) Assignee: Mitsubishi Electric Corporation, Tokyo (JP)

(21) Appl. No.: 17/925,984

(22) PCT Filed: Jun. 12, 2020
(86) PCT No.: PCT/JP2020/023132

§ 371 Date: Nov. 17, 2022

(51) Int. Cl. B62D 6/00; B60W 30/12; B60W 50/08; B62D 15/02

(52) U.S. Cl. CPC B62D 6/008; B60W 30/12; B60W 50/08; B62D 15/025

(57) ABSTRACT

The automatic steering control that changes the traveling direction of the vehicle according to the road information on the travel path to the own vehicle that is automatically driven on the travel path, based on the steering force of the driver's operation of the steering wheel detected by the steering force detector and the lateral deviation of the own vehicle detected by the lateral deviation calculator in the direction perpendicular to the travel direction on the travel path, compared to when the lateral deviation is small corresponding to the magnitude of the lateral deviation, when the lateral deviation is large, the automatic steering control amount acting on the steering force is controlled so that the automatic steering control amount acting on the steering force of the steering wheel operation by the driver becomes larger.

### TECHNICAL FIELD

The present application relates to an automatic steering control device and an automatic steering control system for a vehicle.

### BACKGROUND ART

In an automatic steering control device that automatically steers the steering wheel of a vehicle, a technique for canceling the automatic steering control based on the steering of the driver has been proposed. For example, Patent Document 1 below discloses a technique of canceling the automatic steering mode and switching to the power steering mode when the steering torque of the steering wheel becomes a predetermined value or more in the automatic steering mode.

Further, in Patent Document 2, when the traveling position of the vehicle increases outward with respect to the target path, a technique that alerts the driver to deviation by increasing the steering reaction force acting on the steering of the driver has been proposed.

[Patent Literature 1] JP H4-55168 A

[Patent Literature 2] JP 2019-182303 A

### DISCLOSURE OF INVENTION

### Technical Problem

In the technique of Patent Document 1, even when the lateral deviation, with respect to the target path of the vehicle is increasing, when the steering torque applied to the steering wheel by the driver steering increases, the automatic steering is canceled or restricted as when the lateral deviation is small. Therefore, if the driver unintentionally steers the steering wheel while the lateral deviation of the running vehicle is increasing, if the automatic steering is canceled or restricted immediately, the driver may feel uneasy or uncomfortable.

Further, in the technique of Patent Document 2, the driver is alerted by applying a steering reaction force when the lateral deviation with respect to the target path increases due to the steering operation of the driver, but the steering reaction force is given by changing the reference point used for calculating the target path for automatic steering and increasing the control amount, even if the driver intentionally applies a large steering force to increase the lateral deviation, automatic steering or driving support are not properly released, and when avoiding obstacles, if the target route is erroneously generated, the driver will feel annoyed, and automatic steering or steering support in a direction different from the intention of the driver will be continued.

The present application discloses a technique made in view of the above circumstances, and the purpose is to appropriately control automatic steering or steering support in response to the steering intention of the driver.

### Solution to Problem

The automatic steering control device for vehicle disclosed in the present application is an automatic steering control device for vehicle; wherein,

based on a calculation result of the automatic steering control amount calculation part that calculates the automatic steering control amount, the automatic steering control device for vehicle performs an automatic steering control that changes the traveling direction of an own vehicle according to a road information on a travel path to the own vehicle that is automatically driven on the travel path, and wherein,

based on a steering force of a driver's operation of the steering wheel detected by a steering force detection part and a lateral deviation of the own vehicle detected by a lateral deviation calculation part in the direction perpendicular to the traveling direction on the travel path, compared to when the lateral deviation is small corresponding to the magnitude of the lateral deviation, when the lateral deviation is large, the automatic steering control amount is controlled so that the automatic steering control amount acting on the steering force of the steering wheel operation by the driver becomes larger.

Further, the other automatic steering control device for vehicle disclosed in the present application is an automatic steering control device for vehicle; wherein,

based on a calculation result of the automatic steering control amount calculation part that calculates the automatic steering control amount, the automatic steering control device for vehicle performs an automatic steering control that changes the traveling direction of an own vehicle according to a road information on a travel path to the own vehicle that is automatically driven on the travel path, and wherein,

based on a steering force of a driver's operation of the steering wheel detected by a steering force detection part and a lateral deviation of the own vehicle detected by a lateral deviation calculation part in the direction perpendicular to the traveling direction on the travel path, compared to when the lateral deviation is large corresponding to the magnitude of the lateral deviation, when the lateral deviation is small, the automatic steering control amount acting on the steering force is controlled so that the automatic steering control amount acting on the steering force of the steering wheel operation by the driver becomes smaller.

Furthermore, another automatic steering control device for vehicle disclosed in the present application is an automatic steering control device for vehicle; wherein,

based on a calculation result of the automatic steering control amount calculation part that calculates the automatic steering control amount, the automatic steering control device for vehicle performs an automatic steering control that changes the traveling direction of an own vehicle according to a road information on a travel path to the own vehicle that is automatically driven on the travel path, and wherein,

based on the steering force of a driver's operation of the steering wheel detected by a steering force detection part and a lateral acceleration of the own vehicle detected by a lateral acceleration detection part, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger.

Furthermore, another automatic steering control device for vehicle disclosed in the present application is an automatic steering control device for vehicle; wherein,

based on a calculation result of the automatic steering control amount calculation part that calculates the automatic steering control amount, the automatic steering control device for vehicle performs an automatic steering control that changes the traveling direction of an own vehicle according to a road information on a travel path to the own vehicle that is automatically driven on the travel path, and wherein,

based on the steering force of a driver's operation of the steering wheel detected by the steering force detection part and a lateral acceleration of the vehicle detected by a lateral acceleration detection part, compared to when the lateral acceleration is large corresponding to the magnitude of the lateral acceleration, when the lateral acceleration is small, the automatic steering control amount acting on the steering force is controlled so that the automatic steering control amount acting on the steering force of the steering wheel operation by the driver becomes smaller.

Further, the automatic steering control system for a vehicle disclosed in the present application is an automatic steering control system for a vehicle, wherein,

in the automatic steering control system for a vehicle, an automatic steering control that changes the travel direction of an own vehicle according to a road information on a travel path is performed by an automatic steering control device based on the calculation results of an automatic steering control amount calculation part that calculates the automatic steering control amount, wherein,

the automatic steering control system for vehicle provides a steering force detection part that detects the steering force of the operation of the steering wheel by the driver, and a lateral deviation calculation part that detects the lateral deviation in the direction perpendicular to the traveling direction of the own vehicle on the travel path, and wherein,

the automatic steering control that changes the traveling direction of the vehicle according to the road information on the travel path to the own vehicle that is automatically driven on the travel path, based on the steering force of the driver's operation of the steering wheel detected by the steering force detection part and the lateral deviation of the own vehicle detected by the lateral deviation calculation part in the direction perpendicular to the travel direction on the travel path, compared to when the lateral deviation is small corresponding to the magnitude of the lateral deviation, when the lateral deviation is large, the automatic steering control amount acting on the steering force is controlled so that the automatic steering control amount acting on the steering force of the steering wheel operation by the driver becomes larger.

Further, the automatic steering control system for a vehicle disclosed in the present application is an automatic steering control system for a vehicle, wherein,

in the automatic steering control system for a vehicle, an automatic steering control that changes the travel direction of an own vehicle according to a road information on a travel path is performed by an automatic steering control device based on the calculation results of an automatic steering control amount calculation part that calculates the automatic steering control amount, wherein,

the automatic steering control system for vehicle provides a steering force detection part that detects the steering force of the operation of the steering wheel by the driver, and a lateral deviation calculation part that detects the lateral deviation in the direction perpendicular to the traveling direction of the own vehicle on the travel path, and wherein,

the automatic steering control that changes the traveling direction of the vehicle according to the road information on the travel path to the own vehicle that is automatically driven on the travel path, based on the steering force of the driver's operation of the steering wheel detected by the steering force detection part and the lateral deviation of the own vehicle detected by the lateral deviation calculation part in the direction perpendicular to the travel direction on the travel path, compared to when the lateral deviation is large corresponding to the magnitude of the lateral deviation, when the lateral deviation is small, the automatic steering control amount acting on the steering force is controlled so that the automatic steering control amount acting on the steering force of the steering wheel operation by the driver becomes smaller.

Further, the automatic steering control system for a vehicle disclosed in the present application is an automatic steering control system for a vehicle, wherein,

in the automatic steering control system for a vehicle, the automatic steering control that changes the travel direction of an own vehicle according to the road information on a travel path is performed by an automatic steering control device based on the calculation results of an automatic steering control amount calculation part that calculates the automatic steering control amount, wherein,

the automatic steering control system for vehicle provides a steering force detection part that detects the steering force of the operation of the steering wheel by the driver, and a lateral acceleration detection part that detects the lateral acceleration, and wherein,

the automatic steering control that changes the traveling direction of the own vehicle according to the road information on the travel path to the own vehicle that is automatically driven on the travel path, based on the steering force of the driver's operation of the steering wheel detected by the steering force detection part and the lateral acceleration of the own vehicle detected by the lateral acceleration detection part, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger.

Further, the other automatic steering control system for vehicle disclosed in the present application is an automatic steering control system for a vehicle, wherein,

in the automatic steering control system for a vehicle, an automatic steering control that changes the travel direction of an own vehicle according to the road information on a travel path is performed by an automatic steering control device based on the calculation results of an automatic steering control amount calculation part that calculates the automatic steering control amount, wherein,

the automatic steering control system for vehicle provides a steering force detection part that detects the steering force of the operation of the steering wheel by the driver, and a lateral acceleration detection part that detects the lateral acceleration, and wherein,

the automatic steering control that changes the traveling direction of the own vehicle according to the road information on the travel path to the own vehicle that is automatically driven on the travel path, based on the steering force of the driver's operation of the steering wheel detected by the steering force detection part and the lateral acceleration of the own vehicle detected by the lateral acceleration detection part, compared to when the lateral acceleration is large corresponding to the magnitude of the lateral acceleration, when the lateral acceleration is small, the automatic steering control amount acting on the steering force is controlled so that the automatic steering control amount acting on the steering force of the steering wheel operation by the driver becomes smaller.

### Advantageous Effects of Invention

According to the present application, in an automatic steering control device or an automatic steering control system,

as an automatic steering control that changes the traveling direction of the vehicle according to the road information on the road to the vehicle that is automatically driven on the driving road, based on the steering force of the driver's operation of the steering wheel detected by the steering force detection part and the lateral acceleration of the vehicle detected by the lateral acceleration detection part, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger, and
as an automatic steering control that changes the traveling direction of an own vehicle according to a road information on a travel path to the own vehicle that is automatically driven on the travel path, based on the steering force of the driver's operation of the steering wheel detected by the steering force detection part and the lateral deviation of the vehicle detected by the lateral deviation calculation part in the direction perpendicular to the travel direction on the travel path, compared to when the lateral deviation is large corresponding to the magnitude of the lateral deviation, when the lateral deviation is small, the automatic steering control amount acting on the steering force is controlled so that the automatic steering control amount acting on the steering force of the steering wheel operation by the driver becomes smaller, automatic steering control or steering support control is appropriately performed in response to the steering intention of the driver.

Further, according to the present application, in an automatic steering control device or an automatic steering control system,

as an automatic steering control that changes the traveling direction of an own vehicle according to a road information on a travel path to the own vehicle that is automatically driven on the travel path, based on the steering force of a driver's operation of the steering wheel detected by a steering force detection part and a lateral acceleration of the own vehicle detected by a lateral acceleration detection part, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger, and
as an automatic steering control that changes the traveling direction of an own vehicle according to a road information on a travel path to the own vehicle that is automatically driven on the travel path, based on the steering force of a driver's operation of the steering wheel detected by the steering force detection part and a lateral acceleration of the vehicle detected by a lateral acceleration detection part, compared to when the lateral acceleration is large corresponding to the magnitude of the lateral acceleration, when the lateral acceleration is small, the automatic steering control amount acting on the steering force is controlled so that the automatic steering control amount acting on the steering force of the steering wheel operation by the driver becomes smaller, automatic steering control or steering support control is appropriately performed in response to the steering intention of the driver.

### BRIEF DESCRIPTION OF DRAWINGS

FIG. 1 is a diagram showing the first embodiment, and is a configuration diagram schematically showing an automatic steering control system in a vehicle from a structural point of view.

FIG. 2 is a diagram showing the first embodiment, and is a block diagram showing an automatic steering control device in an automatic steering control system in a functional block diagram.

FIG. 3 is a diagram showing the first embodiment, and is a block diagram showing an automatic steering control system in a functional block diagram.

FIG. 4 is a diagram showing the first embodiment and is a diagram for explaining a lateral deviation gain.

FIG. 5 is a diagram showing the first embodiment and is a diagram for explaining a lateral acceleration gain.

FIG. 6 is a diagram showing the first embodiment and is a diagram for explaining a steering force upper limit gain.

FIG. 7 is a diagram showing the first embodiment and is a diagram for explaining an automatic steering control limit gain.

FIG. 8 is a diagram showing the first embodiment and is a flowchart showing the operation of the automatic steering control system.

FIG. 9 is a diagram showing the first embodiment, and is a system configuration diagram schematically showing an automatic steering control system and a system configuration of an automatic steering control system.

FIG. 10 is a diagram showing the first embodiment and is a conceptual diagram for explaining the relationship between automatic steering control and lateral deviation for a vehicle traveling on a travel path.

### DESCRIPTION OF EMBODIMENTS

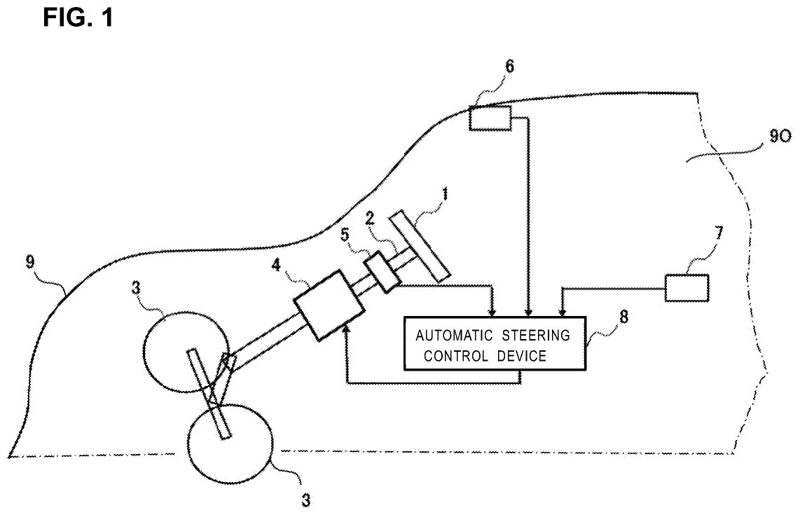

The first embodiment of the present invention will be described below with reference to FIG. 1 to FIG. 10. Further, in the following description, the vehicle equipped with the automatic steering control device according to the embodiment of the present application will be referred to as “own vehicle”.

### First Embodiment

FIG. 1 is a diagram showing the first embodiment of the present application, and is a configuration diagram schematically showing an automatic steering control system in an own vehicle from a structural point of view. In FIG. 1, is a device that changes the direction of the own vehicle by steering the left and right steering wheels 3 according to the rotation of the steering wheel shaft 2 connected to the steering wheel 1 provided on the own vehicle body 9 of the own vehicle, in the motor 4, the steering wheel 3 can be steered by generating a motor torque with respect to the steering wheel shaft 2. In the automatic steering control device 8 which is also called a steering controller, based on the steering force applied to the steering wheel 1 by the driver detected by the steering force detection part 5, the own vehicle position information detected by the own vehicle position detection part 6 and the lateral acceleration detected by the lateral acceleration detector, the current required to generate the motor torque in the motor 4 is supplied.

In the automatic steering control system 80 and the automatic steering control device 8 in the system 80 exemplified in the first embodiment, from the output steering force of the steering force detection part 5, the own vehicle position which is the output of the own vehicle position detection part 6, and the lateral acceleration which is the output of the lateral acceleration detection part 7, the function of calculating the current supplied to the steering actuator 4 such as the motor in the steering controller 8 must be executed by the software installed in the automatic steering control device 8 configured by the microcomputer.

The steering control system of the present application applies to anyone of the “fully automatic steering control system or fully automatic steering control device”, in which a driver or other person covers problems caused by the system's automatic driving of the own vehicle, and the “steering support control system or steering support control device” that assists the driver's driving on the system side.

In the “fully automatic steering control system or fully automatic steering control device” or the “steering support control system or steering support control device”, as illustrated in FIG. 10, when there is roadblock 10RO on travel path 10 of the left side lane marking 10LL and the right side lane marking 10RL, for example, for the lateral deviation at each point P1, P2, P3, P4, P5 along the travel route 10TL to become LD-P1, LD-P2, LD-P3, LD-P4, LD-P5, in other words, as shown in FIG. 10, for the tracing to be illustrated by the thick arrow, the automatic steering control of the own vehicle 90 is performed. The points P1, P2, and P3 are in the straight-line area of the travel path 10, and the points P4 and P5 are in the travel path curve area 10RC.

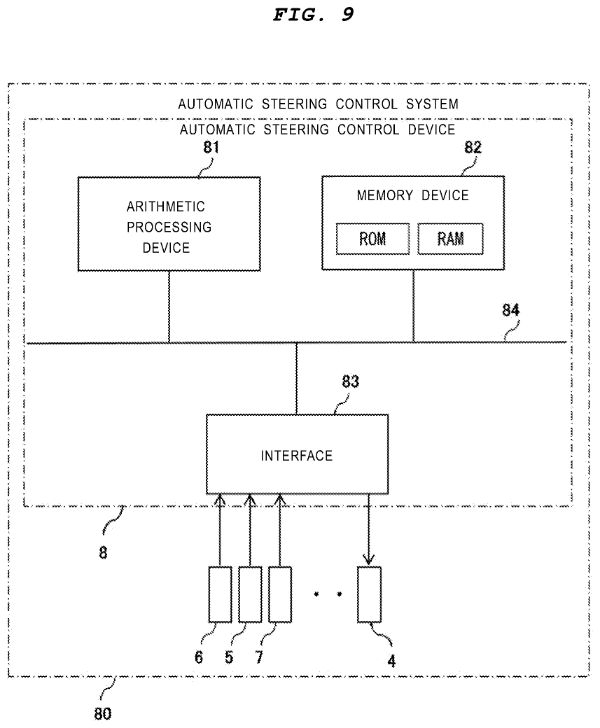

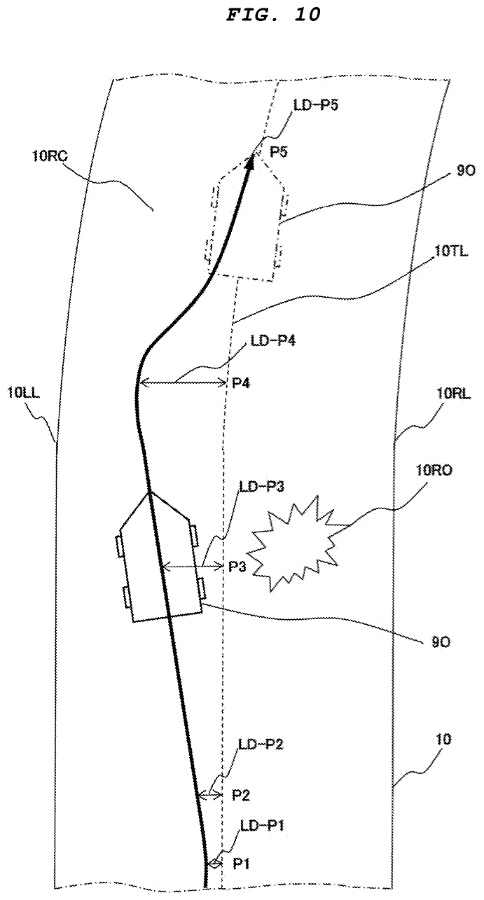

The automatic steering control device 8 of the automatic steering control system 80 is as illustrated in FIG. 9 is composed of an arithmetic processing device 81, a storage device 82 having a ROM as a read-only memory, a RAM as a random-access memory, and an interface 83. The arithmetic processing device 81, the storage device 82, and the interface 83 are connected to each other via the internal bus 84.

For example, the output signal of the own vehicle position detection part 6 input to the interface 83 and stored in the RAM, in other words, the position signal of the own vehicle with respect to the target route, the output signal of the steering force detection part 5, in other words, the steering force signal, which is the force for operating the steering wheel by the driver, and the output signal of the lateral acceleration detection part 7, in other words, the acceleration signal that acts on the own vehicle in the lateral direction (direction perpendicular to the traveling direction of the own vehicle) when the own vehicle travels on the traveling path curve, according to the program stored in the ROM, executes the arithmetic processing necessary for the steering control system of the present application and the automatic steering control device in the system with the arithmetic processing part 81, executes a software such as temporarily saving the result of the calculation in the RAM, performs predetermined control operations required for the steering control system of the present application and the automatic steering control device in the system as follows.

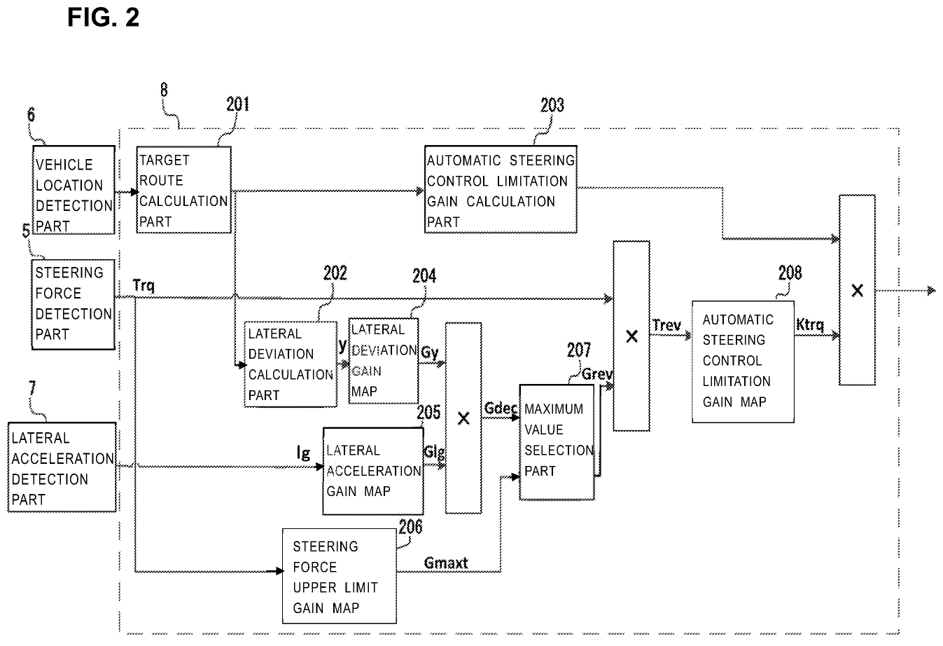

First, a main part of the automatic steering control device 8 of a vehicle, which is also called a steering controller or a steering control part, and an outline of its operation will be described with reference to FIG. 2.

The automatic steering control device 8 has a target route calculation part 201, a lateral deviation calculation part 202, which calculates the lateral deviation based on the result of the target route calculation part 201, and an automatic steering control amount calculation part 203 that calculates the automatic steering control amount required to follow the own vehicle to the target route, but these calculations may use well-known techniques used in own vehicle lane keeping control, and as a method for calculating the lateral deviation of the own vehicle with respect to the target route and a method for calculating the automatic steering control amount, a well-known calculation method may be adopted.

Here, a method of calculating the automatic steering control limit gain Ktrq that limits the calculated automatic steering control amount according to the steering of the driver will be described.

The lateral deviation gain Gy is calculated in the lateral deviation gain map 204 based on the lateral deviation y calculated based on the own vehicle position output from the own vehicle position detection part 6. Further, the lateral acceleration gain Glg is calculated in the lateral acceleration gain map 205 based on the lateral acceleration lg output by the lateral acceleration detection part 7. The product of the calculated lateral deviation gain Gy and the lateral acceleration gain Glg is output as the limit suppression gain Gdec.

In the steering force upper limit gain map 206, the steering force upper limit gain Gmaxt is output based on the steering force detected by the steering force detection part 5. In the maximum value selection part 207, the limit suppression gain Gdec and the steering force upper limit gain Gmaxt are compared, and the larger value is set as the limit rate correction gain Grev.

Based on the corrected steering torque Trev, which is the result of taking the product of the steering force Trq detected by the steering force detection part 5 and the limit factor correction gain Grev calculated by the maximum value selection part 207, the automatic steering control limit gain Ktrq is calculated in the automatic steering control limit gain map 208. By taking the product of the calculated automatic steering control limit gain Ktrq and the automatic steering control amount calculated by the automatic steering control amount calculation part 203, the control output for the actuator 4 such as a motor is determined, when the actuator 4 is a motor, the drive current of the motor is determined.

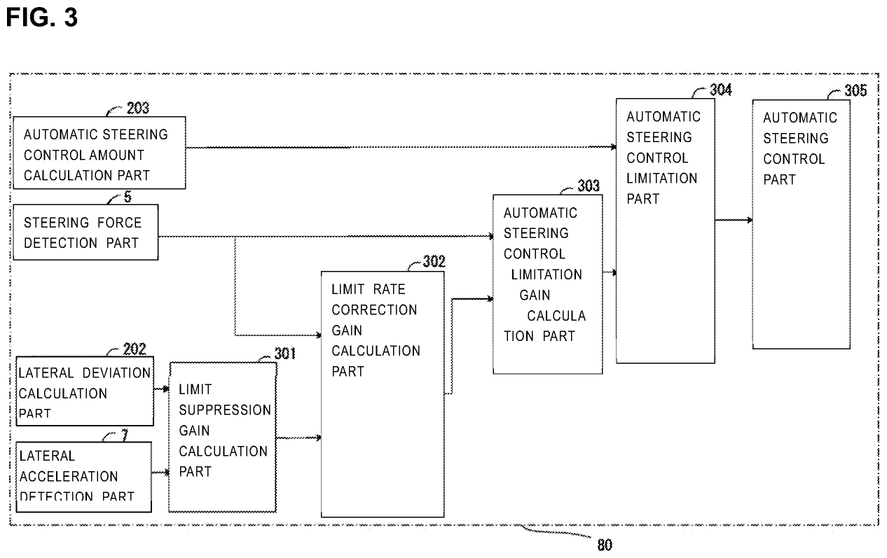

The detailed processing flow of each gain map will be described below based on the functional block diagram of FIG. 3.

FIG. 3 is a functional block diagram showing the configuration of the automatic steering control system 80 according to the first embodiment. As shown in FIG. 3, the automatic steering control device provides an automatic steering control amount calculation part 203, a steering force detection part 5, a lateral deviation calculation part 202, a lateral acceleration detection part 7, a limit suppression gain calculation part 301, a limit factor correction gain calculation part 302, an automatic steering control limit gain calculation part 303, an automatic steering control limit part 304 and an automatic steering control part 305.

The automatic steering control amount calculation part 203 (see FIGS. 2 and 3) calculates the control amount to the actuator 4 required to change the own vehicle traveling direction so that the own vehicle follows the target route. The target route is calculated from the lane information obtained from the camera attached to the own vehicle, the LIDAR (Light Detector and Raging), the trajectory of the preceding vehicle traveling ahead, map information and own vehicle position information, the steering angle control amount required to follow the target route is calculated by the automatic steering control amount calculation part 203. The steering angle control amount is calculated by the automatic steering control amount calculation part 203 according to the deviation between the target steering angle required to follow the target route and the actual steering angle. Further, the control amount may be calculated according to the deviation between the target steering torque required to follow the target route and the actual detected steering torque.

The steering force detection part 5 outputs the steering force applied to the steering wheel by the driver as the steering torque detected by the torque sensor.

The lateral deviation calculation part 202 detects the lateral deviation of the own vehicle with respect to the target route of the own vehicle. The lateral deviation may be the lateral deviation at the current traveling position of the own vehicle, or the lateral deviation at the front gaze destination of the own vehicle may be used.

The lateral acceleration detection part 7 outputs the value detected by the sensor for the lateral acceleration generated in the own vehicle or the curvature-converted lateral acceleration converted from the product of the target route curvature and the square of the own vehicle speed as the lateral acceleration.

The limit suppression gain calculation part 301 calculates the limit suppression gain Gdec based on the lateral deviation y of the own vehicle detected by the lateral deviation calculation part 202 and the lateral acceleration lg generated in the own vehicle detected by the lateral acceleration detection part.

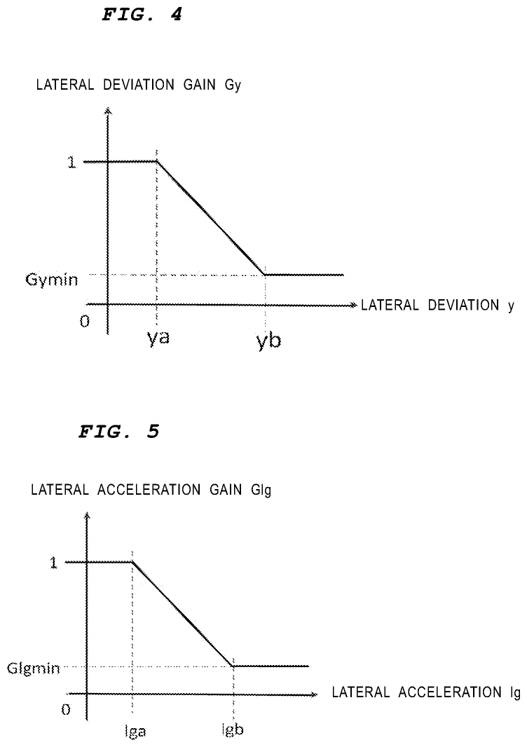

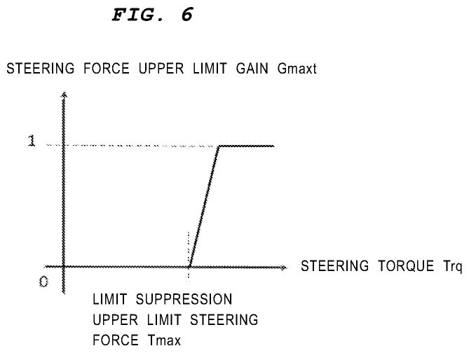

For example, when the lateral deviation is small as shown in FIG. 4, the value is set close to 1, when the lateral deviation gain Gy is set so that the gain approaches 0 as the lateral deviation increases, and when the lateral acceleration is small as shown in FIG. 5, the value is set close to 1, and the limit suppression gain Gdec is calculated by multiplying the lateral acceleration gain Glg set to approach 0 as the lateral acceleration increases as shown in (Equation 1) below.

Gdec=Gy×Glg (Equation 1)

The lateral deviation gain Gy starts to decrease from the gain 1 when the lateral deviation becomes ya, and is maintained at the lower limit gain Gymin when the lateral deviation is yb or more. As a result, the limit suppression gain Gdec does not decrease near the target route with a lateral deviation of ya or less, and the steering intention of the driver is given higher priority, but as the lateral deviation of the own vehicle increases, the limit suppression gain Gdec decreases, and the amount of release or restriction of automatic steering control or steering support control, for the steering of the driver decreases. The maximum amount of suppression of the control limit rate due to the increase in lateral deviation is determined by Gymin.

Similarly, the lateral acceleration gain Glg starts to decrease from the gain 1 when the lateral acceleration becomes lga, and is maintained at the gain Glgmin when the lateral acceleration is lgb or more. As a result, on a straight road with a lateral acceleration of lga or less, the limit suppression gain Gdec is calculated according to the lateral deviation gain Gy, but, in the case of driving on a curve and the lateral acceleration exceeds lga, the limit suppression gain Gdec is calculated to further decreases as the magnitude of the lateral acceleration increases. The maximum amount of suppression of the control limit rate due to the increase in lateral deviation is determined by the lower limit gain Glgmin.

The limit factor correction gain calculation part 302 takes a limit suppression gain Gdec calculated by the limit suppression gain calculation part 301 and a value close to 0 when the steering torque by the driver detected by the steering force detection part 5 is small, and compare with the steering force upper limit gain Gmaxt, which takes a value close to 1 when the steering torque exceeds a certain value, the larger value is output to the automatic steering control limit gain calculation part 303 as the limit rate correction gain Grev.

Grev=max (Gdec, Gmaxt) (Equation 2)

For example, the lateral deviation increases when the limit suppression gain Gdec is close to 0, by setting the steering force upper limit gain Gmaxt, which becomes a value close to 1 when the steering torque exceeds the value set as the limit suppression upper limit steering force Tmax as shown in FIG. 6, even when the limit suppression gain Gdec is close to 0, the limit factor correction gain is close to 1 when the steering torque exceeds the limit suppression upper limit steering force. The magnitude of the limit suppression upper limit steering force is set to a magnitude that allows the driver to reasonably overcome the automatic steering.

The automatic steering control limit gain calculation part 303 calculates the automatic steering control limit gain Ktrq based on the steering torque Trq output from the steering force detection part 5 and the corrected steering torque Trev, which is the product of the limit factor correction gain Grev output from the limit factor correction gain calculation part 302, and is output to the automatic steering control limit part 304.

Trev=Trq×Grev (Equation 3)

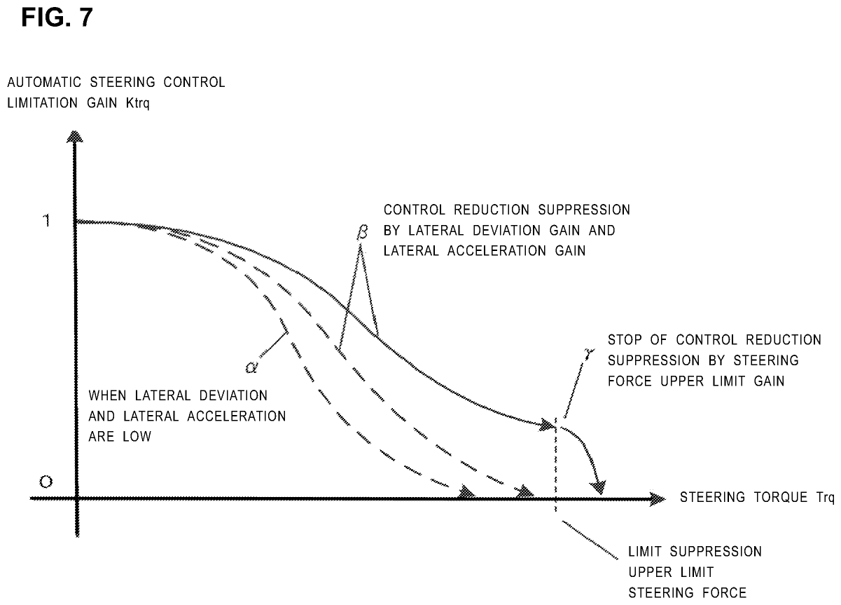

For example, to explain based on FIG. 7, in the case of FIG. 10, when the own vehicle 90 is on a straight road near the center of the road (point P1), when the lateral anomaly (LD-P1) and the lateral acceleration are small, since the limit suppression gain Gdec takes a value close to 1, the corrected steering torque Trev, which is the product of the steering torque and the limit factor correction gain, takes a value close to the steering torque Trq by the driver, the automatic steering control limit gain Ktrq that decreases as the steering torque increases as shown by a in FIG. 7 is output. On the other hand, when the own vehicle position increases in the deviation direction (lateral deviation increases) due to driver steering on a straight road, when the lateral acceleration is increasing by (Point P1 (lateral deviation LD-P1), point P2 (lateral deviation LD-P2), point P3 (lateral deviation LD-P3) in FIG. 10), or by the curve of the traveling path 10 (point P4 (lateral deviation LD-P4), P5 (lateral deviation LD-P5) in FIG. 10), by taking a value close to 0, the limit suppression gain Gdec, the product of the steering torque and the limit factor correction gain is smaller than the steering torque, as shown by β in FIG. 7, the decrease in the automatic steering control limit gain becomes smaller as the steering torque increases. Further, when the lateral deviation and lateral acceleration are increasing, such as when own the vehicle position is increasing in the deviation direction on a curve, the value of the limit factor correction gain takes a value closer to 0, since the corrected steering torque value is even smaller than the steering torque, reduction of automatic steering control limit gain is suppressed, but, when the steering torque at that time reaches the limit suppression upper limit steering force, the steering force upper limit gain increases and the restriction suppression is stopped, so the corrected steering torque becomes a value close to the steering torque, as a result, the automatic steering control limit gain approaches 0 as shown in γ in FIG. 7.

The automatic steering control limit part 304 limits the automatic steering control amount calculated by the automatic steering control amount calculation part 203 based on the automatic steering limit gain calculated by the automatic steering control limit gain calculation part 303. For example, when the steering torque due to driver steering increases when the lateral deviation of the own vehicle with respect to the target path is small on a straight road, since the lateral deviation gain and the lateral acceleration gain are close to 1, the limit suppression gain is also close to 1. Therefore, the limit rate of the automatic steering control with respect to the steering torque of the steering wheel by the driver becomes large. On the other hand, if the lateral deviation of the own vehicle is large, the lateral acceleration generated in the own vehicle is large, and the steering force by the driver does not exceed the limit suppression upper limit gain, the limit rate of automatic steering control with respect to the steering torque by the driver is corrected to be small.

The automatic steering control part 305 controls the own vehicle to follow the target route based on the restricted automatic steering control amount calculated by the automatic steering control limit part 304. As mentioned above, if the lateral deviation of the own vehicle is increasing, the lateral acceleration generated in the own vehicle is large, the limit rate of automatic steering control for the steering torque by the driver becomes smaller, automatic steering control is less likely to be released or restricted.

In this way, based on the lateral deviation with respect to the target path of the own vehicle detected by the lateral deviation calculation part 202 and the lateral acceleration generated in the own vehicle detected by the lateral acceleration detection part 7, the automatic steering control limit gain calculation part 303 can calculate the automatic steering control limit gain that suppresses the limit rate of the automatic operation control amount corresponding to the driver steering force according to the lateral deviation or the lateral acceleration. As a result, by canceling or limit the automatic steering according to the steering force of the driver, when lateral deviation or lateral acceleration increase, the automatic steering is canceled or the limit amount is reduced by the automatic steering control limit part 304, by reducing the anxiety felt by the driver due to unintentional cancellation or restriction of automatic steering, and by not releasing or limit control by driver steering in the event of avoidance of road obstacle 10RO or error of target route, it is possible to reduce the annoyance felt at the same time.

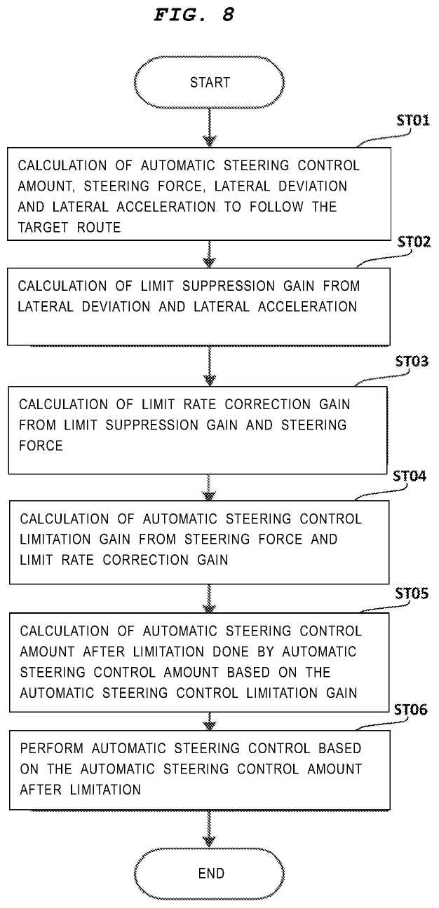

Hereinafter, the operation of the automatic steering control device according to the first embodiment will be described with reference to the flowchart of FIG. 8. The flowchart of FIG. 8 shows a process of one cycle, and the vehicle traveling support device repeatedly executes this process as necessary.

When the automatic steering control device starts operation, in step ST01, the lateral deviation calculation part 202 and the lateral acceleration detection part 7 detect the lateral deviation and the lateral acceleration, and output the lateral deviation and the lateral acceleration to the limit suppression gain calculation part 301. Further, the automatic steering control amount calculation part 203 calculates the automatic steering control amount, and the steering force detecting part 5 detects the steering force.

In step ST02, based on the lateral deviation and lateral acceleration detected in step ST01, the limit suppression gain, which is the product of the lateral deviation gain that changes according to the lateral deviation and the lateral acceleration gain that changes according to the lateral acceleration, is calculated.

In step ST03, the limit suppression gain and the steering force upper limit gain that changes from 0 to a value close to 1 when the steering force detected by the steering force detection part 5 exceeds a certain value are used, the limit rate correction gain calculation part 302 calculates the limit rate correction gain.

In step ST04, the automatic steering control limit gain is calculated from the steering force detected by the steering force detection part 5 and the limit rate correction gain is output by the limit rate correction gain calculation part 302.

In step ST05, by taking the product of the automatic steering control amount output by the automatic steering control amount calculation part 203 and the automatic steering control limit gain output by the automatic steering control limit gain calculation part 303, the restricted automatic steering control amount is calculated by reducing the automatic steering control amount according to the steering torque.

In step ST06, automatic steering control is performed based on the restricted automatic steering control amount is output by the automatic steering control limit part 304.

Although the embodiment of the present application has been described above, it is intended to appropriately release or suppress control of the steering of the driver during automatic steering, not only steering assist with electric power steering, but also steering assist, and it can also be applied to vehicles having a steering mechanism such as steer-by-wire and variable gear ratio.

Further, the lateral deviation gain, the lateral acceleration gain, and the steering force upper limit gain are all shown to increase or decrease linearly in the present embodiment, but the method of increasing or decreasing does not have to be linear. Furthermore, although each gain is provided with a dead zone so that it changes after the input becomes a certain value or more, the dead zone may not be provided, and the gain may be increased or decreased in response to a change in the input value.

The limit suppression gain was calculated by multiplying the lateral deviation gain and the lateral acceleration gain, but the minimum values of the lateral deviation gain and the lateral acceleration gain may be set as the limit suppression gain.

Further, although the upper limit value of the steering force upper limit gain is set to 1, when the limit suppression upper limit steering force is exceeded, it is set to a value of 1 or more, the limit rate may be increased to give priority to driver steering.

As is apparent from the above description and each of the drawings, the first embodiment has the following first technical characteristics 1 to 7.

Technical Characteristic 1:

To suppress the control decrease based on the lateral deviation increase, an automatic steering control device or an automatic steering control system that corrects in order to the limit rate of the automatic steering control amount due to the automatic steering control limit gain becomes smaller as the lateral deviation becomes larger, and is equipped with the automatic steering control amount calculation part that calculates the automatic steering control amount for automatically following the own vehicle on the target route, the steering force detector that detects the steering force of the driver on the steering wheel, the lateral deviation detection part that obtains the lateral deviation with respect to the target route of the own vehicle, the automatic steering control limit gain calculation part that calculates the automatic steering control limit gain that reduces the automatic steering control amount as the steering force increases, the automatic steering control limit part that limits the automatic steering control amount based on the gain and then sets it as the automatic steering control amount, the automatic steering control part that performs automatic steering control of the own vehicle based on the amount of automatic steering control after restriction, when the lateral deviation increases, the automatic steering control is less likely to be released or restricted.

Technical Characteristic 2:

The automatic steering control device or automatic steering control system of the Technical characteristic 1, when the lateral acceleration is large on a curve, the control decrease is further suppressed, is equipped with a lateral acceleration detection part that detects the lateral acceleration generated in the own vehicle, the limit rate of the amount of automatic steering control by the automatic steering control limit gain is corrected so that it becomes smaller as the lateral deviation increases, the larger the lateral acceleration, the smaller the limit rate of the automatic steering control amount due to the automatic steering control limit gain, the tighter the curve, the less likely it is that automatic steering control will be released or restricted.

Technical Characteristic 3:

In the automatic steering control device or automatic steering control system of Technical characteristic 1 or 2, in order to calculate the control limit suppression gain by lateral deviation gain X lateral acceleration gain, when a lateral deviation occurs on a curve, the automatic steering control is less likely to be released or restricted, the automatic steering control limit gain calculation part limits the amount of automatic steering control based on the lateral deviation correction gain calculated by the limit suppression gain calculation part so that the larger the lateral deviation, the smaller the limit factor of the automatic steering control amount due to the automatic steering control limit gain and the limit suppression gain, which is the product of the lateral acceleration correction gain, such that the larger the lateral acceleration, the smaller the limit rate of the automatic steering control amount due to the automatic steering control limit gain.

Technical Characteristic 4:

In the automatic steering control device or automatic steering control system of Technical characteristics 1 to 4, in order to calculate the amount of control reduction by steering torque X limit suppression gain, the automatic steering control limit gain calculation part calculates the automatic steering control limit gain based on the product of the limit suppression gain and the steering force, it is possible to correct the limit rate that changes as the steering torque increases with lateral deviation and lateral acceleration.

Technical Characteristic 5:

In the automatic steering control device or automatic steering control system according to any one of the Technical characteristics 1 to 4, in order to stop the control reduction suppression if the steering torque is too large, the automatic steering control limit gain calculation part calculates the automatic steering control limit gain based on the limit rate correction gain corrected so as to stop the decrease of the limit rate due to the limit suppression gain when the steering force exceeds a certain level, when the steering torque is too large, it is possible to increase the limit rate and give priority to the steering of the driver even when the lateral deviation or lateral acceleration increase.

Technical Characteristic 6:

According to the embodiment of the present application, automatic steering control or steering support control can be appropriately released or restricted according to the intention of the driver.

Technical Characteristic 7:

Both reduction of annoyance coming from the driver's anxiety is reduced by immediately canceling and suppressing the automatic steering control when the lateral deviation increases, and the automatic steering control is not released or restricted even though the driver is steering.

In the drawings, the same reference numerals indicate the same or corresponding parts.

The embodiment can be appropriately modified or omitted.

Although various exemplary embodiments and examples are described in this application, the various features, modes, and functions described in one or more embodiments are not limited to the application of a particular embodiment, but can be applied to embodiments alone or in various combinations.

Accordingly, countless variations not illustrated are envisioned within the scope of the art disclosed in this application. For example, this shall include cases where at least one component is transformed, added or omitted, and even where at least one component is extracted and combined with components of other embodiments.

### REFERENCE SIGNS LIST

1. Steering wheel,
2. Steering wheel axis,
3. Steering wheel,
4. Steering actuator,
5. Steering force detection part,
6. Own vehicle position detection part,
7. Lateral acceleration detection part,
8. Automatic steering control device,
80. Automatic steering control system,
9. Vehicle body,
90. Own vehicle,
10. Travel path,
10TL. Travel route,
10LL. Left side lane marking,
10RL. Right side lane marking,
10RC. Travel path curve area,
10RO. Roadblock,
P1, P2, P3, P4. Point,
LD-P1, LD-P2, LD-P3, LD-P4, LD-P5. Lateral deviation,
201. Target route calculation part,
202. Lateral deviation calculation part,
203. Automatic steering control amount calculation part,
204. Lateral deviation gain map,
205. Lateral acceleration gain map,
206. Steering force upper limit gain map,
207. Maximum value selection part,
208. Automatic steering control limitation gain map,
301. Limit suppression gain calculation part,
302. Limit rate correction gain calculation part,
303. Automatic steering control limitation gain calculation part,
304. Automatic steering control limitation part,
305. Automatic steering control part.

1-12. (canceled)

13. An automatic steering control device for vehicle; wherein,
based on a calculation result of the automatic steering control amount calculator that calculates the automatic steering control amount, the automatic steering control device for vehicle performs an automatic steering control that changes the traveling direction of an own vehicle according to a road information on a travel path to the own vehicle that is automatically driven on the travel path, and wherein,
based on a steering force of a driver's operation of the steering wheel detected by a steering force detector and a lateral deviation of the own vehicle detected by a lateral deviation calculator in the direction perpendicular to the traveling direction on the travel path, compared to when the lateral deviation is small corresponding to the magnitude of the lateral deviation, when the lateral deviation is large, the automatic steering control amount is controlled so that the automatic steering control amount acting on the steering force of the steering wheel operation by the driver becomes larger.

14. An automatic steering control device for vehicle; wherein,
based on a calculation result of the automatic steering control amount calculator that calculates the automatic steering control amount, the automatic steering control device for vehicle performs an automatic steering control that changes the traveling direction of an own vehicle according to a road information on a travel path to the own vehicle that is automatically driven on the travel path, and wherein,
based on a steering force of a driver's operation of the steering wheel detected by a steering force detector and a lateral deviation of the own vehicle detected by a lateral deviation calculator in the direction perpendicular to the traveling direction on the travel path, compared to when the lateral deviation is large corresponding to the magnitude of the lateral deviation, when the lateral deviation is small, the automatic steering control amount acting on the steering force is controlled so that the automatic steering control amount acting on the steering force of the steering wheel operation by the driver becomes smaller.

15. The automatic steering control device for vehicle according to claim 13, wherein,
the automatic steering control amount is controlled based on the lateral deviation gain that changes according to the magnitude of the lateral deviation of the lateral deviation calculator.

16. The automatic steering control device for vehicle according to claim 14, wherein,
the automatic steering control amount is controlled based on the lateral deviation gain that changes according to the magnitude of the lateral deviation of the lateral deviation calculator.

17. An automatic steering control device for vehicle; wherein,
based on a calculation result of the automatic steering control amount calculator that calculates the automatic steering control amount, the automatic steering control device for vehicle performs an automatic steering control that changes the traveling direction of an own vehicle according to a road information on a travel path to the own vehicle that is automatically driven on the travel path, and wherein,
based on the steering force of a driver's operation of the steering wheel detected by a steering force detector and a lateral acceleration of the own vehicle detected by a lateral acceleration detector, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger.

18. An automatic steering control device for vehicle; wherein,
based on a calculation result of the automatic steering control amount calculator that calculates the automatic steering control amount, the automatic steering control device for vehicle performs an automatic steering control that changes the traveling direction of an own vehicle according to a road information on a travel path to the own vehicle that is automatically driven on the travel path, and wherein,
based on the steering force of a driver's operation of the steering wheel detected by the steering force detector and a lateral acceleration of the vehicle detected by a lateral acceleration detector, compared to when the lateral acceleration is large corresponding to the magnitude of the lateral acceleration, when the lateral acceleration is small, the automatic steering control amount acting on the steering force is controlled so that the automatic steering control amount acting on the steering force of the steering wheel operation by the driver becomes smaller.

19. The automatic steering control device for vehicle according to claim 17, wherein,
the amount of automatic steering control acting on the steering force is controlled based on the lateral acceleration gain that changes according to the magnitude of the lateral acceleration detected by the lateral acceleration detector.

20. The automatic steering control device for vehicle according to claim 18, wherein,
the amount of automatic steering control acting on the steering force is controlled based on the lateral acceleration gain that changes according to the magnitude of the lateral acceleration detected by the lateral acceleration detector.

21. An automatic steering control system for vehicle; wherein,
in the automatic steering control system for a vehicle, an automatic steering control that changes the travel direction of an own vehicle according to a road information on a travel path is performed by an automatic steering control device based on the calculation results of an automatic steering control amount calculator that calculates the automatic steering control amount, wherein,
the automatic steering control system for vehicle provides a steering force detector that detects the steering force of the operation of the steering wheel by the driver, and a lateral deviation calculator that detects the lateral deviation in the direction perpendicular to the traveling direction of the own vehicle on the travel path, and wherein,
the automatic steering control that changes the traveling direction of the vehicle according to the road information on the travel path to the own vehicle that is automatically driven on the travel path, based on the steering force of the driver's operation of the steering wheel detected by the steering force detector and the lateral deviation of the own vehicle detected by the lateral deviation calculator in the direction perpendicular to the travel direction on the travel path, compared to when the lateral deviation is small corresponding to the magnitude of the lateral deviation, when the lateral deviation is large, the automatic steering control amount acting on the steering force is controlled so that the automatic steering control amount acting on the steering force of the steering wheel operation by the driver becomes larger.

22. An automatic steering control system for vehicle; wherein,
in the automatic steering control system for a vehicle, an automatic steering control that changes the travel direction of an own vehicle according to a road information on a travel path is performed by an automatic steering control device based on the calculation results of an automatic steering control amount calculator that calculates the automatic steering control amount, wherein,
the automatic steering control system for vehicle provides a steering force detector that detects the steering force of the operation of the steering wheel by the driver, and a lateral deviation calculator that detects the lateral deviation in the direction perpendicular to the traveling direction of the own vehicle on the travel path, and wherein,
the automatic steering control that changes the traveling direction of the vehicle according to the road information on the travel path to the own vehicle that is automatically driven on the travel path, based on the steering force of the driver's operation of the steering wheel detected by the steering force detector and the lateral deviation of the own vehicle detected by the lateral deviation calculator in the direction perpendicular to the travel direction on the travel path, compared to when the lateral deviation is large corresponding to the magnitude of the lateral deviation, when the lateral deviation is small, the automatic steering control amount acting on the steering force is controlled so that the automatic steering control amount acting on the steering force of the steering wheel operation by the driver becomes smaller.

23. The automatic steering control system for vehicle according to claim 21, wherein,
the automatic steering control amount acting on the steering force is controlled based on the lateral deviation gain that changes according to the magnitude of the lateral deviation of the lateral deviation calculator.

24. The automatic steering control system for vehicle according to claim 22, wherein,
the automatic steering control amount acting on the steering force is controlled based on the lateral deviation gain that changes according to the magnitude of the lateral deviation of the lateral deviation calculator.

25. An automatic steering control system for vehicle; wherein,
in the automatic steering control system for a vehicle, the automatic steering control that changes the travel direction of an own vehicle according to the road information on a travel path is performed by an automatic steering control device based on the calculation results of an automatic steering control amount calculator that calculates the automatic steering control amount, wherein,
the automatic steering control system for vehicle provides a steering force detector that detects the steering force of the operation of the steering wheel by the driver, and a lateral acceleration detector that detects the lateral acceleration, and wherein,
the automatic steering control that changes the traveling direction of the own vehicle according to the road information on road of the travel path to the own vehicle that is automatically driven on the travel path, based on the steering force of the driver's operation of the steering wheel detected by the steering force detector and the lateral acceleration of the own vehicle detected by the lateral acceleration detector, compared to when the lateral acceleration is small corresponding to the magnitude of the lateral acceleration, when the lateral acceleration is large, the automatic steering control amount acting on the steering force is controlled so that the automatic steering control amount acting on the steering force of the steering wheel operation by the driver becomes larger.

26. An automatic steering control system for vehicle; wherein,
in the automatic steering control system for a vehicle, an automatic steering control that changes the travel direction of an own vehicle according to the road information on a travel path is performed by an automatic steering control device based on the calculation results of an automatic steering control amount calculator that calculates the automatic steering control amount, wherein,
the automatic steering control system for vehicle provides a steering force detector that detects the steering force of the operation of the steering wheel by the driver, and a lateral acceleration detector that detects the lateral acceleration, and wherein,
the automatic steering control that changes the traveling direction of the own vehicle according to the road information on the road of the travel path to the own vehicle that is automatically driven on the travel path, based on the steering force of the driver's operation of the steering wheel detected by the steering force detector and the lateral acceleration of the own vehicle detected by the lateral acceleration detector, compared to when the lateral acceleration is large corresponding to the magnitude of the lateral acceleration, when the lateral acceleration is small, the automatic steering control amount acting on the steering force is controlled so that the automatic steering control amount acting on the steering force of the steering wheel operation by the driver becomes smaller.

27. The automatic steering control system for vehicle according to claim 25, wherein,
the amount of automatic steering control acting on the steering force is controlled based on the lateral acceleration gain that changes according to the magnitude of the lateral acceleration detected by the lateral acceleration detector.

28. The automatic steering control system for vehicle according to claim 26, wherein,
the amount of automatic steering control acting on the steering force is controlled based on the lateral acceleration gain that changes according to the magnitude of the lateral acceleration detected by the lateral acceleration detector.
